(19) United States
(12) Patent Application Publication
(10) Pub. No.: US 2024/0394352 A1
(43) Pub. Date: Nov. 28, 2024

(54) AUTHENTICATION APPARATUS, AUTHENTICATION METHOD, AND PROGRAM

(71) Applicant: NEC Corporation, Tokyo (JP)

(72) Inventors: Yuta SHIMIZU, Tokyo (JP); Toshiyuki ISSHIKI, Tokyo (JP); Kengo MORI, Tokyo (JP); Kazuki INAGAKI, Tokyo (JP); Koyo SHIBATA, Tokyo (JP); Kohei HIJIKATA, Tokyo (JP)

(73) Assignee: NEC Corporation, Tokyo (JP)

(21) Appl. No.: 18/667,073

(22) Filed: May 17, 2024

(30) Foreign Application Priority Data
May 26, 2023 (JP) 2023-086911

(51) Int. Cl. G06F 21/32

(52) U.S. Cl. CPC G06F 21/32

(57) ABSTRACT

An authentication apparatus includes biometric information acquiring part which acquires first biometric information of user, certification information adding part, authentication part, and biometric information database which includes second biometric information of user stored in advance. The certification information adding part receives first biometric information from biometric information acquiring part, generates certification information concerning communication rule, notifies authentication part of certification information in advance, and transmits authentication information including certification information and first biometric information configured according to the communication rule shown by certification information to authentication part. The authentication part receives authentication information, verifies legitimacy of certification information in authentication information received using certification information notified in advance, and performs authentication of user using first biometric information in authentication information according to the communication rule shown by certification information with reference to second biometric information in a case where certification information is determined to be legitimate.

### CROSS REFERENCE TO RELATED APPLICATIONS

The present invention is based upon and claims the benefit of the priority of Japanese patent application No. 2023-086911, filed on May 26, 2023, the disclosure of which is incorporated herein in its entirety by reference thereto.

### FIELD

The present invention relates to an authentication apparatus, an authentication method, and a program.

### Background

There is a document below as a document relating to an authentication apparatus and an authentication method.

Patent Literature (PTL) 1 relates to an authentication apparatus which does not leak a secret key and biometric information.

PTL 2 relates to a biometric information authentication system in which generation of biometric information from a part of a biometric body is not necessary whenever personal authentication is requested to an apparatus performing a personal authentication.
PTL 1: Japanese Patent Kokai Publication No: 2011-211593
PTL 2: Japanese Patent Kokai Publication No: 2009-217749

### SUMMARY

The following analysis has been given by the present inventors.

A face authentication ECU (Electronic Control Unit) is mounted on the vehicle, and so on, and the user is authenticated by face authentication, whereby it becomes possible that a legitimate user uses a vehicle, and so on, when. A face authentication ECU, however, cannot identify a route through which biometric information used for authentication is acquired. For example, a face authentication ECU cannot discriminate whether biometric information used for a face authentication is acquired through a legitimate route by shooting a user by a camera, or biometric information used for a face authentication has been theft in advance by a fraudulent user and is inputted directly to a face authentication ECU through a communication bus, and so on, in a vehicle. Therefore, if the biometric information theft in advance by a fraudulent user is inputted directly to a face authentication ECU, authentication by face authentication is performed to a fraudulent user, which results in that the fraudulent user is authenticated.

It is an object of the present invention to provide an authentication apparatus, an authentication method, and a program which is capable to contribute to prevent a user authentication using biometric information other than biometric information acquired through a legitimate route from being performed.

According to a first aspect of the present invention, there is provided an authentication apparatus, comprising:
a biometric information acquiring part which acquires first biometric information of a user;
a certification information adding part;
an authentication part; and
a biometric information database which includes second biometric information of the user;
wherein the certification information adding part
notifies the authentication part of certification information concerning a communication rule in advance, and
transmits authentication information including the certification information and the first biometric information configured according to the communication rule to the authentication part; and
wherein the authentication part
receives the authentication information, and
verifies legitimacy of the certification information in the authentication information using the certification information notified in advance from the certification information adding part; and
performs authentication of the user using the first biometric information in the authentication information with reference to the second biometric information included in the biometric information database, in a case where the certification information in the authentication information is determined to be legitimate.

According to a second aspect of the present invention, there is provided an authentication method performed by an authentication apparatus, comprising:
a biometric information acquiring part which acquires first biometric information of a user;
a certification information adding part;
an authentication part; and
a biometric information database which includes second biometric information of the user;
wherein the certification information adding part
notifies the authentication part of certification information concerning a communication rule in advance, and
transmits authentication information including the certification information and the first biometric information configured according to the communication rule to the authentication part; and
wherein the authentication part
receives the authentication information, and
verifies legitimacy of the certification information in the authentication information using the certification information notified in advance from the certification information adding part; and
performs authentication of the user using the first biometric information in the authentication information with reference to the second biometric information included in the biometric information database, in a case where the certification information in the authentication information is determined to be legitimate. The present method is tied to a particular machine, namely, a computer which performs an authentication method.

According to a third aspect of the present invention, there is provided a program which causes a computer in an authentication apparatus comprising:
a biometric information acquiring part which acquires first biometric information of a user, and
a biometric information database which includes second biometric information of the user,
to perform processings of:
notifying certification information concerning a communication rule in advance, and
transmitting authentication information including the certification information and the first biometric information configured according to the communication rule,
whereby the program causes the computer to realize a function of a certification information adding part; and
causes the computer to perform processings of:
receiving the authentication information, and
verifying legitimacy of the certification information in the authentication information using the certification information notified in advance from the processing of notifying in advance; and
performing authentication of the user using the first biometric information in the authentication information with reference to the second biometric information included in the biometric information database, in a case where the certification information in the authentication information is determined to be legitimate,
whereby the program causes the computer to realize a function of an authentication part.

Note, this program can be recorded in a computer-readable storage medium. The storage medium can be non-transitory one, such as a semiconductor memory, a hard disk, a magnetic recording medium, an optical recording medium, and so on. The present invention can be realized by a computer program product.

According to a fourth aspect of the present invention, there is provided an authentication apparatus, comprising:
a biometric information acquiring part which acquires first biometric information of a user;
a certification information adding part;
an authentication part; and
a biometric information database which includes second biometric information of the user stored in advance;
wherein the certification information adding part
   receives the first biometric information from the biometric information acquiring part,
   generates certification information concerning a communication rule,
notifies the authentication part of certification information concerning the communication rule in advance, and
transmits authentication information including the certification information concerning the communication rule and the first biometric information configured according to the communication rule shown by the certification information concerning the communication rule to the authentication part; and
wherein the authentication part
receives the authentication information from the certification information adding part, and
verifies legitimacy of the certification information concerning the communication rule in the authentication information received from the certification information adding part using the certification information concerning the communication rule notified in advance from the certification information adding part; and
performs authentication of the user using the first biometric information in the authentication information according to the communication rule shown by the certification information concerning the communication rule with reference to the second biometric information included in the biometric information database, in a case where the certification information concerning the communication rule in the authentication information is determined to be legitimate.

According to a fifth aspect of the present invention, there is provided an authentication method performed by an authentication apparatus, comprising:
a biometric information acquiring part which acquires first biometric information of a user;
a certification information adding part;
an authentication part; and
a biometric information database which includes second biometric information of the user stored in advance;
wherein the certification information adding part
   receive the first biometric information,
   generates certification information concerning a communication rule,
notifies the authentication part of certification information concerning the communication rule in advance, and
transmits authentication information including the certification information concerning the communication rule and the first biometric information configured according to the communication rule shown by the certification information concerning the communication rule to the authentication part; and
wherein the authentication part
receives the authentication information from the certification information adding part, and
verifies legitimacy of the certification information concerning the communication rule in the authentication information received from the certification information adding part using the certification information concerning the communication rule notified in advance from the certification information adding part; and
performs authentication of the user using the first biometric information in the authentication information according to the communication rule shown by the certification information concerning the communication rule with reference to the second biometric information included in the biometric information database, in a case where the certification information concerning the communication rule in the authentication information is determined to be legitimate. The present method is tied to a particular machine, namely, a computer which performs an authentication method.

According to a sixth aspect of the present invention, there is provided a program which causes a computer in an authentication apparatus comprising:
a biometric information acquiring part which acquires first biometric information of a user, and
a biometric information database which includes second biometric information of the user stored in advance,
to perform processings of:
receiving the first biometric information,
generating certification information concerning a communication rule, notifying certification information concerning the communication rule in advance, and
transmitting authentication information including the certification information concerning the communication rule and the first biometric information configured according to the communication rule shown by the certification information concerning the communication rule,
whereby the program causes the computer to realize a function of a certification information adding part; and
causes the computer to perform processings of:
receiving the authentication information, and
verifying legitimacy of the certification information concerning the communication rule in the authentication information received using the certification information concerning the communication rule notified in advance from the processing of notifying in advance; and
performing authentication of the user using the first biometric information in the authentication information according to the communication rule shown by the certification information concerning the communication rule with reference to the second biometric information, in a case where the certification information concerning the communication rule in the authentication information is determined to be legitimate,
whereby the program causes the computer to realize a function of an authentication part.

Note, this program can be recorded in a computer-readable storage medium. The storage medium can be non-transitory one, such as a semiconductor memory, a hard disk, a magnetic recording medium, an optical recording medium, and so on. The present invention can be realized by a computer program product.

According to the present invention, it is possible to provide an authentication apparatus, an authentication method, and a program which is capable to contribute to prevent a user authentication using biometric information other than biometric information acquired through a legitimate route from being performed.

### BRIEF DESCRIPTION OF DRAWINGS

FIG. 1 is a diagram illustrating an example of a configuration of an authentication apparatus according to an example embodiment of the present invention.

FIG. 2 is a diagram illustrating an example of a configuration of an authentication apparatus according to a first example embodiment of the present invention.

FIG. 3 is a diagram illustrating an example of an operation of a certification information adding part according to the first example embodiment of the present invention.

FIG. 4 is a diagram illustrating an example of a configuration of an authentication apparatus according to a second example embodiment of the present invention.

FIG. 5 is a diagram illustrating an example of an operation of a certification information adding part according to the second example embodiment of the present invention.

FIG. 6 is a diagram illustrating an example of a configuration of an authentication apparatus according to a third example embodiment of the present invention.

FIG. 7 is a diagram illustrating an example of an operation of a certification information adding part according to the third example embodiment of the present invention.

FIG. 8 is a diagram illustrating a configuration of a computer which can make up an authentication apparatus according to the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and are not intended to any limitation. An individual connection line between blocks in the drawings, etc., referred to in the following description includes both one-way and two-way directions. A one-way arrow schematically illustrates a principal signal (data) flow and does not exclude bidirectionality.

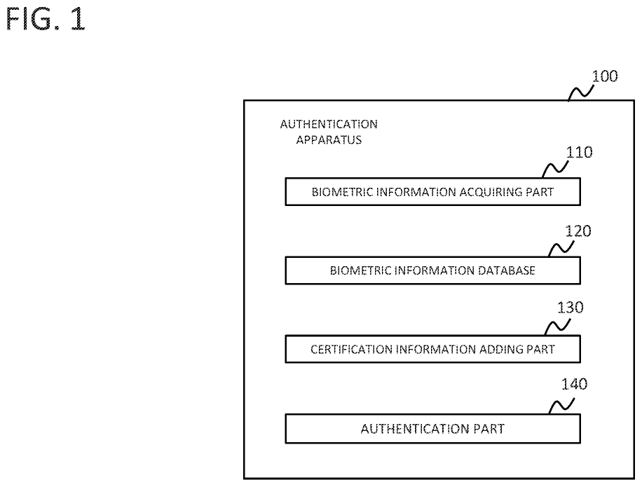

FIG. 1 is a diagram illustrating an example of a configuration of an authentication apparatus according to an example embodiment of the present invention. With reference to FIG. 1, an authentication apparatus 100 includes a biometric information acquiring part 110 which acquires first biometric information of a user to be authenticated, a certification information adding part 130, an authentication part 140 and a biometric information database 120 which includes second biometric information of the user to be authenticated. Note, first biometric information and second biometric information are information concerning a face of a user and, for example, may be information including a face image, and so on, or a feature value of a face extracted from a face image, and so on. Furthermore, it is assumed that first biometric information and second biometric information are generated from a face image of a user using a same processing method in such way that they are comparable. In the example embodiment of the present invention, as to second biometric information of a user to be authenticated, biometric information of a user to be authenticated acquired by a biometric information acquiring part 110 may be stored in a biometric information database 120 in advance at a registration stage, and so on. In another way, second biometric information of a user to be authenticated may be generated in advance outside the authentication apparatus 100 and stored in a biometric information database 120 in advance, at a registration stage.

The certification information adding part 130 notifies the authentication part 140 of certification information concerning a communication rule in advance and transmits authentication information including the certification information and the first biometric information configured according to the communication rule to the authentication part 140.

The authentication part 140 receives the authentication information and verifies legitimacy of the certification information in the authentication information using the certification information notified in advance from the certification information adding part 130.

In addition, the authentication part 140 performs authentication of the user using the first biometric information in the authentication information with reference to the second biometric information included in the biometric information database 120, in a case where the certification information in the authentication information is determined to be legitimate.

As described above, according to the example embodiment of the present invention, it is possible to provide an authentication apparatus, an authentication method, and a program which is capable to contribute to prevent a user authentication using biometric information other than biometric information acquired by a biometric information acquiring part 110 through a legitimate route from being performed because an authentication of a user is performed using the first biometric information in the authentication information only in a case where legitimacy of the certification information concerning a communication rule in the authentication information is verified and the certification information in the authentication information is determined to be legitimate.

### First Example Embodiment

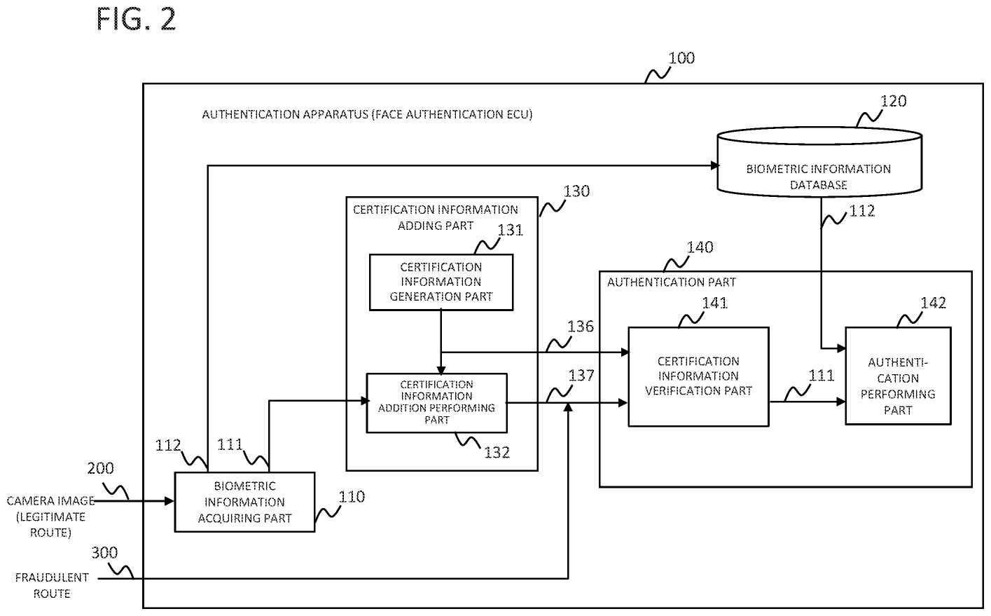

Next, an authentication apparatus of a first example embodiment of the present invention will be described with reference to drawings. FIG. 2 is a diagram illustrating an example of a configuration of an authentication apparatus according to the first example embodiment of the present invention. In FIG. 2, components denoted by the same reference numerals as those in FIG. 1 indicate the same components. An authentication apparatus (also called a face authentication ECU (Electronic Control Unit)) 100 includes a biometric information acquiring part 110 which acquires first biometric information 111 of a user to be authenticated and second biometric information 112 of the user to be authenticated, a certification information adding part 130, an authentication part 140 and a biometric information database 120 which includes second biometric information 112 of the user to be authenticated stored in advance at a registration stage and so on. A certification information adding part 130 includes a certification information generation part 131 and a certification information addition performing part 132. Furthermore, an authentication part 140 includes a certification information verification part 141 and an authentication performing part 142.

An authentication apparatus 100 shown in FIG. 2 has an input 200 which receives a camera image, as an example, and a camera image and so on is inputted to a biometric information acquiring part 110 through the input 200. Note, it is assumed that a route through which a camera image and so on is inputted to the biometric information acquiring part 110 from the input 200 whereby a biometric information is acquired is a legitimate route.

As an example, in a case where an authentication apparatus 100 is connected to a communication bus, and so on, which connects electronic parts in a vehicle in which the authentication apparatus 100 is mounted, a fraudulent user may be able to access an authentication part 140 through the communication bus in the vehicle by connecting a computer and so on outside the vehicle to the communication bus. It is assumed that a route through which a computer and so on outside a vehicle directly access an authentication part 140 is a fraudulent route 300. As an example, a fraudulent user has theft second biometric information 112 of a user stored in a biometric information database 120 in advance and, subsequently, may directly input the second biometric information 112 to the authentication part 140 through the fraudulent route 300.

However, it is not possible for an authentication performing part 142 in an authentication part 140 to determine whether or not supplied biometric information has been acquired by a theft. Therefore, in the case where second biometric information 112 of a user stored in a biometric information database 120 in advance has been theft by a fraudulent user and inputted to an authentication part 140 through a fraudulent route 300, if the certification information adding part 130 and the certification information verification part 141 as shown in FIG. 2 are not provided, the authentication performing part 142 performs an authentication of the user using the second biometric information 112 which has been theft with reference to the second biometric information 112 of the user stored in the biometric information database 120 in advance. In such case, the authentication of the fraudulent user may result in success.

In the first example embodiment of the present invention, by the certification information adding part 130 and the certification information verification part 141 of the authentication part 140, it is possible to prevent an authentication of a user using biometric information other than biometric information acquired by the biometric information acquiring part 110 through a legitimate route from being performed.

With reference to FIG. 2, a case where an authentication of a user is performed using biometric information acquired through a legitimate route will be described.

First, at a registration stage, a face of a user to be authenticated is shot by a camera and a face image thereof is inputted to a biometric information acquiring part 110 from an input 200. The biometric information acquiring part 110 acquires second biometric information 112 of a user to be authenticated from the face image. Then, acquired second biometric information 112 is stored in a biometric information database 120 in advance.

Note, in the first example embodiment of the present invention, for convenience in explanation, although it is described that a biometric information acquiring part 110 acquires second biometric information 112 of a user to be authenticated and the second biometric information 112 is stored in a biometric information database 120 in advance at a registration stage, second biometric information 112 of a user to be authenticated may have been acquired outside the authentication apparatus 100 and may have been stored in biometric information database 120 in advance.

Next, when a user performs authentication, a face of the user is shot again by a camera and the face image is inputted to the biometric information acquiring part 110 from the input 200. The biometric information acquiring part 110 acquires first biometric information 111 of the user from inputted face image and transmit the first biometric information 111 to the certification information adding part 130. Note, first biometric information and second biometric information are information concerning a face of a user and, for example, may be information including a face image, and so on, or a feature value of a face extracted from a face image, and so on. Furthermore, it is assumed that first biometric information 111 and second biometric information 112 are generated from a face image of a user by a same processing method in such way that they are comparable.

The certification information addition performing part 132 of the certification information adding part 130 receives the first biometric information 111 from the biometric information acquiring part 110. The certification information generation part 131 of the certification information adding part 130 generates certification information 136 concerning a communication rule and notifies the certification information verification part 141 in the authentication part 140 of the certification information 136 concerning a communication rule in advance. Furthermore, the certification information addition performing part 132 of the certification information adding part 130 receives the certification information 136 concerning a communication rule from the certification information generation part 131 and transmits authentication information 137 including the certification information 136 concerning the communication rule and the first biometric information 111 configured according to the communication rule shown by the certification information 136 concerning the communication rule to the certification information verification part 141 of the authentication part 140.

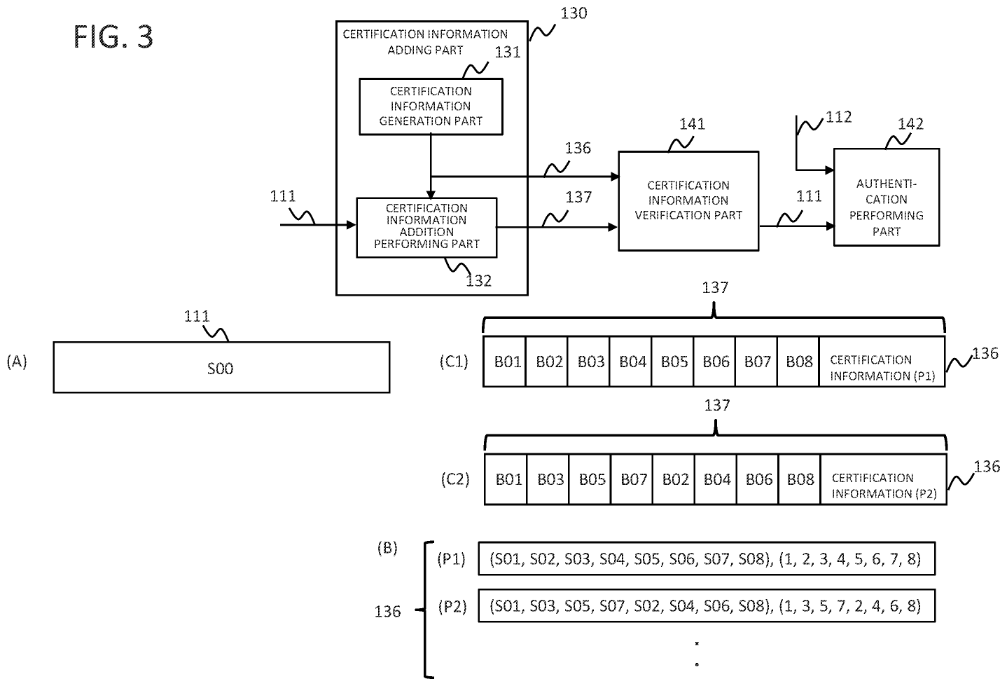

Next, an example of an operation of the certification information generation part 131 will be described with reference to FIG. 3. FIG. 3 is a diagram illustrating an example of an operation of a certification information adding part 130 according to the first example embodiment of the present invention. The certification information generation part 131 generates the certification information 136 concerning a communication rule based on a communication rule used when the certification information addition performing part 132 transmits the inputted first biometric information 111 to the certification information verification part 141.

As an example, the certification information generation part 131 generates the certification information 136 concerning a communication rule as shown in (B) of FIG. 3.

“(P1) (S01, S02, S03, S04, S05, S06, S07, S08), (1, 2, 3, 4, 5, 6, 7, 8)” as shown in (B) of FIG. 3 represents an example of the certification information 136 concerning a communication rule generated by the certification information generation part 131. The communication rule shown by the certification information 136 concerning a communication rule of “(P1) (S01, S02, S03, S04, S05, S06, S07, S08), (1, 2, 3, 4, 5, 6, 7, 8)” is a communication rule which represents that first biometric information 111 of a size S00 inputted to the certification information addition performing part 132 is divided to 8 blocks B01 to B08, respective blocks B01 to B08 have sizes of S01 to S08, and the blocks B01 to B08 are transmitted from the certification information addition performing part 132 to the certification information verification part 141 in an order of B01, B02, B03, B04, B05, B06, B07 and B08. (1, 2, 3, 4, 5, 6, 7, 8) represents the transmission order of the divided blocks and (S01, S02, S03, S04, S05, S06, S07, S08) represents the sizes S01, S02, S03, S04, S05, S06, S07, S08 of respective blocks B01, B02, B03, B04, B05, B06, B07 and B08 in a transmission order. The certification information 136 concerning a communication rule of “(P1) (S01, S02, S03, S04, S05, S06, S07, S08), (1, 2, 3, 4, 5, 6, 7, 8)” generated as described above is transmitted from the certification information generation part 131 to the certification information addition performing part 132. At the same time, the certification information 136 concerning a communication rule of “(P1) (S01, S02, S03, S04, S05, S06, S07, S08), (1, 2, 3, 4, 5, 6, 7, 8)” is transmitted to the certification information verification part 141 of the authentication part 140.

“(P2) (S01, S03, S05, S07, S02, S04, S06, S08), (1, 3, 5, 7, 2, 4, 6, 8)” as shown in (B) of FIG. 3 represents another example of the certification information 136 concerning a communication rule generated by the certification information generation part 131. The communication rule shown by the certification information 136 concerning a communication rule of “(P2) (S01, S03, S05, S07, S02, S04, S06, S08), (1, 3, 5, 7, 2, 4, 6, 8)” is a communication rule which represents that first biometric information 111 inputted to the certification information addition performing part 132 is divided to 8 blocks B01 to B08, respective blocks B01 to B08 have sizes of S01 to S08, and the blocks B01 to B08 are transmitted from the certification information addition performing part 132 to the certification information verification part 141 in an order of B01, B03, B05, B07, B02, B04, B06 and B08. (1, 3, 5, 7, 2, 4, 6, 8) represents the transmission order of the divided blocks and (S01, S03, S05, S07, S02, S04, S06, S08) represents the sizes S01, S03, S05, S07, S02, S04, S06, S08 of respective blocks B01, B03, B05, B07, B02, B04, B06, B08 in a transmission order. The certification information 136 concerning a communication rule of “(P2) (S01, S03, S05, S07, S02, S04, S06, S08), (1, 3, 5, 7, 2, 4, 6, 8)” generated as described above is transmitted from the certification information generation part 131 to the certification information addition performing part 132. At the same time, the certification information 136 concerning a communication rule of (P2) is transmitted to the certification information verification part 141 of the authentication part 140.

Note, the above certification information 136 concerning a communication rule is just one example and it is not intended to be restricted to content as described above. It is possible to generate certification information 136 concerning a communication rule using any communication rule and a way of expression thereof used for transmission from the certification information addition performing part 132 to the certification information verification part 141. Furthermore, in a case where a plurality of communication rules and symbols or signs and so on associated to the plurality of communication rules are known to both the certification information adding part 130 and an authentication part 140 in advance, certification information 136 concerning a communication rule may be generated by selecting symbols or signs and so on associated to a communication rule to be used among a plurality of communication rules. For example, in a case where “(P1) (S01, S02, S03, S04, S05, S06, S07, S08), (1, 2, 3, 4, 5, 6, 7, 8)” and “(P2) (S01, S03, S05, S07, S02, S04, S06, S08), (1, 3, 5, 7, 2, 4, 6, 8)” as shown in the above examples are known to both the certification information adding part 130 and an authentication part 140, only “P1” or only “P2” may be generated and used as certification information 136 concerning a communication rule.

Furthermore, it is possible to use different certification information 136 concerning a communication rule from moment to moment. As an example, certification information 136 concerning a communication rule of “(P1) (S01, S02, S03, S04, S05, S06, S07, S08), (1, 2, 3, 4, 5, 6, 7, 8)” as shown in (B) of FIG. 3 can be used at a moment and, on the one hand, certification information 136 concerning a communication rule of “(P2) (S01, S03, S05, S07, S02, S04, S06, S08), (1, 3, 5, 7, 2, 4, 6, 8)” as shown in (B) of FIG. 3 can be used at a different moment. By using different certification information 136 concerning a communication rule from moment to moment, for example in a regular way or randomly, it becomes possible to effectively prevent an authentication of a user using biometric information other than biometric information acquired through a legitimate route from being performed.

(C1) of FIG. 3 shows a case where first biometric information 111 is transmitted from the certification information addition performing part 132 to the certification information verification part 141 using a communication rule shown by the certification information 136 concerning a communication rule of “(P1) (S01, S02, S03, S04, S05, S06, S07, S08), (1, 2, 3, 4, 5, 6, 7, 8)” as shown in (B) of FIG. 3 as generated above. As shown in (C1) of FIG. 3, respective blocks B01, B02, B03, B04, B05, B06, B07 and B08 are transmitted in sequence and, for example, the certification information 136 concerning a communication rule shown by “(P1) (S01, S02, S03, S04, S05, S06, S07, S08), (1, 2, 3, 4, 5, 6, 7, 8)” shown in (B) of FIG. 3 is transmitted at the end. By this, authentication information 137 including the certification information 136 concerning the communication rule and the first biometric information 111 configured according to the communication rule shown by the certification information 136 concerning the communication rule of “(P1) (S01, S02, S03, S04, S05, S06, S07, S08), (1, 2, 3, 4, 5, 6, 7, 8)” are transmitted from the certification information addition performing part 132 of the certification information adding part 130 to the certification information verification part 141 of the authentication part 140. Note, the first biometric information 111 configured according to the communication rule shown by the certification information 136 concerning the communication rule of “(P1) (S01, S02, S03, S04, S05, S06, S07, S08), (1, 2, 3, 4, 5, 6, 7, 8)” represents that the first biometric information 111 to be transmitted is divided to blocks and sizes of the blocks and a transmission order thereof are configured according to a communication rule shown by the certification information 136 concerning the communication rule of “(P1) (S01, S02, S03, S04, S05, S06, S07, S08), (1, 2, 3, 4, 5, 6, 7, 8)”.

(C2) of FIG. 3 shows a case where first biometric information 111 is transmitted from the certification information addition performing part 132 to the certification information verification part 141 using a communication rule shown by the certification information 136 concerning a communication rule “(P2) (S01, S03, S05, S07, S02, S04, S06, S08), (1, 3, 5, 7, 2, 4, 6, 8)” as shown in (B) of FIG. 3 as generated above. As shown in (C2) of FIG. 3, respective blocks B01, B03, B05, B07, B02, B04, B06 and B08 are transmitted and, for example, the certification information 136 concerning a communication rule “(P2) (S01, S03, S05, S07, S02, S04, S06, S08), (1, 3, 5, 7, 2, 4, 6, 8)” shown in (B) of FIG. 3 is transmitted at the end. By this, authentication information 137 including the certification information 136 concerning the communication rule and the first biometric information 111 configured according to the communication rule shown by the certification information 136 concerning the communication rule of “(P2) (S01, S03, S05, S07, S02, S04, S06, S08), (1, 3, 5, 7, 2, 4, 6, 8)” are transmitted from the certification information addition performing part 132 of the certification information adding part 130 to the certification information verification part 141 of the authentication part 140. Note, the first biometric information 111 configured according to the communication rule shown by the certification information 136 concerning the communication rule of “(P2) (S01, S03, S05, S07, S02, S04, S06, S08), (1, 3, 5, 7, 2, 4, 6, 8)” represents that the first biometric information 111 to be transmitted is divided to blocks and sizes of the blocks and a transmission order thereof are configured according to a communication rule shown by the certification information 136 concerning the communication rule of “(P2) (S01, S03, S05, S07, S02, S04, S06, S08), (1, 3, 5, 7, 2, 4, 6, 8)”.

Next, an operation of the certification information verification part 141 of the authentication part 140 which has received certification information 136 concerning a communication rule and authentication information 137 will be described with reference to FIG. 2.

The certification information verification part 141 receives the authentication information 137 from the certification information addition performing part 132 of the certification information adding part 130 and verifies legitimacy of the certification information 136 concerning a communication rule in the authentication information 137 received from the certification information adding part 130 using the certification information 136 concerning a communication rule notified in advance from the certification information generation part 131 of the certification information adding part 130.

In a case where an authentication of a user is performed using biometric information acquired through a legitimate route, certification information 136 concerning a communication rule in authentication information 137 is the same as certification information 136 concerning a communication rule notified in advance from the certification information generation part 131. In such case, the certification information verification part 141 determines that the certification information 136 concerning the communication rule in the authentication information 137 is legitimate. Then, the certification information verification part 141 transmits to the authentication performing part 142 the first biometric information 111 in which an order of the blocks is restored to the same order of the blocks as that in the first biometric information 111 before configuration has been performed according to a communication rule which is shown by the certification information 136 concerning the communication rule, from an order of blocks of the first biometric information 111 configured according to the communication rule represented in the certification information 136 concerning the communication rule in the authentication information 137, based on the certification information 136 concerning the communication rule in the authentication information 137 or notified from the certification information adding part 130 in advance.

The authentication performing part 142 in the authentication part 140, with reference to the second biometric information 112 included in the biometric information database 120, performs an authentication of a user using the first biometric information 111 in which an order of the blocks is restored to the same order of the blocks as that before configuration has been performed according to a communication rule shown by the certification information 136 concerning the communication rule. In another example, an authentication of a user is performed using the first biometric information 111 in the authentication information 137 according to the communication rule shown by the certification information 136 concerning the communication rule.

Next, in the first example embodiment of the present invention as shown in FIG. 2, an operation will be described below, in a case where second biometric information 112 of a user stored in advance in the biometric information database 120 has been stolen by a fraudulent user and is inputted to the authentication part 140 through a fraudulent route 300 without passing through the certification information adding part 130 as authentication information 137 including first biometric information 111.

In a case where certification information 136 concerning a communication rule is not added to authentication information 137 received by the certification information verification part 141 of the authentication part 140 or in a case where certification information 136 concerning a communication rule in received authentication information 137 is incorrect, the certification information verification part 141 determines that authentication information 137 does not contain first biometric information 111 of a user which is inputted through a legitimate route from an input 200 and transmitted from the certification information addition performing part 132 of the certification information adding part 130. Then, the certification information verification part 141 does not transmit the first biometric information 111 in the inputted authentication information 137 to the authentication performing part 142 and halts processings. As a result, the authentication performing part 142 does not performs an authentication of a user.

As a result, it is possible to prevent a user authentication using biometric information other than biometric information acquired through a legitimate route from being performed.

As described above, according to the first example embodiment of the present invention, it is possible to provide an authentication apparatus, an authentication method, and a program which is capable to contribute to prevent a user authentication using biometric information other than biometric information acquired through a legitimate route from being performed because an authentication of a user is performed using the first biometric information 111 only in a case where legitimacy of the certification information 136 concerning a communication rule in the authentication information 137 is verified and the certification information 136 in the authentication information 137 is determined to be legitimate.

### Second Example Embodiment

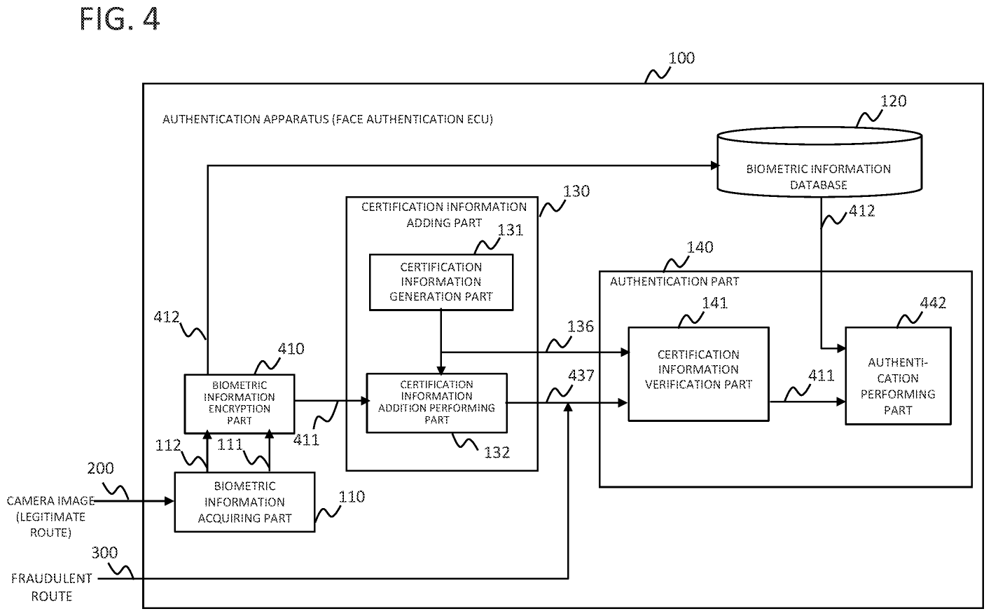

Next, an authentication apparatus of a second example embodiment of the present invention will be described with reference to drawings. FIG. 4 is a diagram illustrating an example of a configuration of an authentication apparatus according to the second example embodiment of the present invention. In FIG. 4, components denoted by the same reference numerals as those in FIG. 2 indicate the same components. An authentication apparatus 100 according to the second example embodiment includes a configuration in which a biometric information encryption part 410 is further provided to the authentication apparatus 100 according to the first example embodiment. The biometric information encryption part 410 encrypts first biometric information 111 using a predetermined encryption, transmits encrypted first biometric information 111 to a certification information adding part 130, and encrypts second biometric information 112 using the predetermined encryption.

Note, as a biometric authentication technology, there are technologies of authenticating a user by performing verification of biometric information such as an inputted camera image and so on, while feature values of a biometric body is kept encrypted or converted, such as a secret biometric authentication technology and a cancellable biometric authentication technology.

In the secret biometric authentication technology, verification is performed by calculating, while still being kept encrypted, a verification result between biometric feature information which is extracted from biometric information and encrypted by a homomorphic encryption, and biometric feature information which is encrypted by a homomorphic encryption and stored in a biometric information database.

A cancellable biometric authentication technology is a technology which uses, for verification, “a feature value irreversibly converted” using “a key” based on a feature value generated from a registered image. Even if the feature value is leaked, the existing feature value can be cancelled by generating another feature value using a new key, whereby “securement of replaceability” can be satisfied.

The second example embodiment of the present invention is an example embodiment of the present invention in which the secret biometric authentication technology as described above is used, as an example.

In the second example embodiment of the present invention, it is described that, as an example, in a registration phase and so on, second biometric information 112 of a user to be authenticated acquired by a biometric information acquiring part 110 is encrypted using a predetermined encryption by the biometric information encryption part 410 and stored in a biometric information database 120 in advance as an encrypted second biometric information 412. However, as to encrypted second biometric information 412 in the biometric information database 120, second biometric information 112 of a user to be authenticated acquired outside an authentication apparatus 100 may be encrypted using a predetermined encryption and the encrypted second biometric information 412 may be stored in the biometric information database 120 in advance at a registration stage and so on.

Furthermore, first biometric information 111 of a user to be authenticated acquired by a biometric information acquiring part 110 is encrypted with a predetermined encryption by the biometric information encryption part 410 and supplied to the certification information addition performing part 132 as encrypted first biometric information 411.

The certification information addition performing part 132 of the certification information adding part 130 receives the encrypted first biometric information 411 from the biometric information encryption part 410. The certification information generation part 131 of the certification information adding part 130 generates certification information 136 concerning a communication rule and notifies the certification information verification part 141 in the authentication part 140 of the certification information 136 concerning a communication rule in advance. Furthermore, the certification information addition performing part 132 of the certification information adding part 130 receives the certification information 136 concerning a communication rule from the certification information generation part 131 and transmits authentication information 437 including the certification information 136 concerning the communication rule and the encrypted first biometric information 411 configured according to the communication rule shown by the certification information 136 concerning the communication rule to the certification information verification part 141 of the authentication part 140.

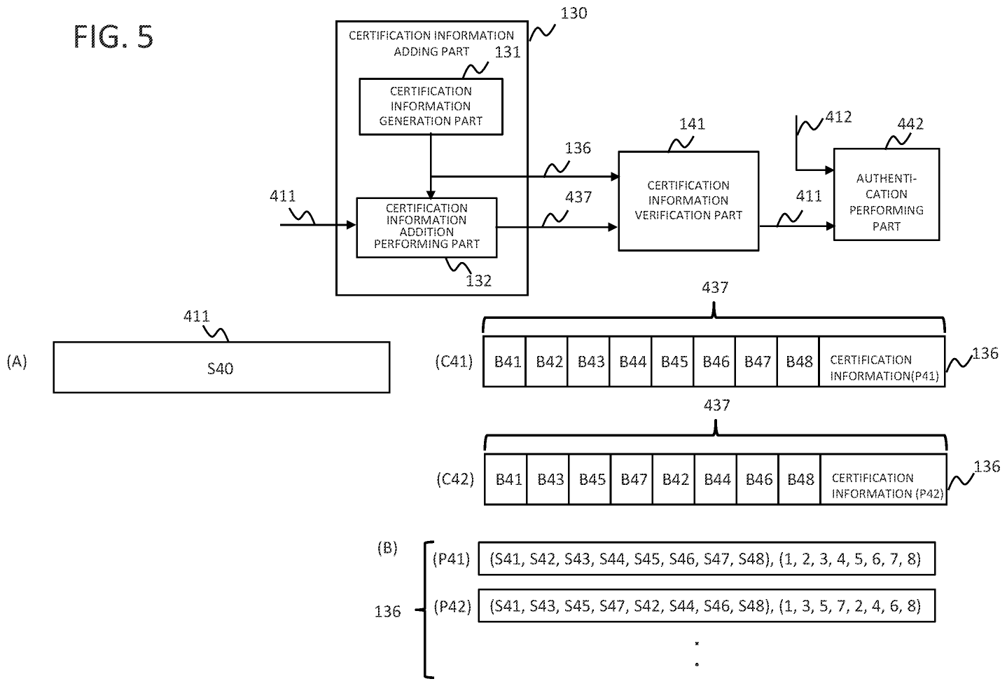

Next, an example of an operation of the certification information generation part 131 will be described with reference to FIG. 5. FIG. 5 is a diagram illustrating an example of an operation of a certification information adding part 130 according to the second example embodiment of the present invention. The certification information generation part 131 generates the certification information 136 concerning a communication rule based on a communication rule used when the certification information addition performing part 132 transmits the inputted encrypted first biometric information 411 to the certification information verification part 141.

As an example, the certification information generation part 131 generates the certification information 136 concerning a communication rule as shown in (B) of FIG. 5.

“(P41) (S41, S42, S43, S44, S45, S46, S47, S48), (1, 2, 3, 4, 5, 6, 7, 8)” as shown in (B) of FIG. 5 represents an example of the certification information 136 concerning a communication rule generated by the certification information generation part 131. The communication rule shown by the certification information 136 concerning a communication rule of “(P41) (S41, S42, S43, S44, S45, S46, S47, S48), (1, 2, 3, 4, 5, 6, 7, 8)” is a communication rule which represents that encrypted first biometric information 411 of a size S40 inputted to the certification information addition performing part 132 is divided to 8 blocks B41 to B48, respective blocks B41 to B48 have sizes of S41 to S48, and the blocks B41 to B48 are transmitted from the certification information addition performing part 132 to the certification information verification part 141 in an order of B41, B42, B43, B44, B45, B46, B47 and B48. (1, 2, 3, 4, 5, 6, 7, 8) represents the transmission order of the divided blocks and (S41, S42, S43, S44, S45, S46, S47, S48) represents the sizes S41, S42, S43, S44, S45, S46, S47, S48 of respective blocks B41, B42, B43, B44, B45, B46, B47 and B48 in a transmission order. The certification information 136 concerning a communication rule of “(P41) (S41, S42, S43, S44, S45, S46, S47, S48), (1, 2, 3, 4, 5, 6, 7, 8)” generated as described above is transmitted from the certification information generation part 131 to the certification information addition performing part 132. At the same time, the certification information 136 concerning a communication rule of “(P41) (S41, S42, S43, S44, S45, S46, S47, S48), (1, 2, 3, 4, 5, 6, 7, 8)” is transmitted to the certification information verification part 141 of the authentication part 140.

“(P42) (S41, S43, S45, S47, S42, S44, S46, S48), (1, 3, 5, 7, 2, 4, 6, 8)” as shown in (B) of FIG. 5 represents another example of the certification information 136 concerning a communication rule generated by the certification information generation part 131. The communication rule shown by the certification information 136 concerning a communication rule of “(P42) (S41, S43, S45, S47, S42, S44, S46, S48), (1, 3, 5, 7, 2, 4, 6, 8)” is a communication rule which represents that encrypted first biometric information 411 of a size S40 inputted to the certification information addition performing part 132 is divided to 8 blocks B41 to B48, respective blocks B41 to B48 have sizes of S41 to S48, and the blocks B41 to B48 are transmitted from the certification information addition performing part 132 to the certification information verification part 141 in an order of B41, B43, B45, B47, B42, B44, B46 and B48. (1, 3, 5, 7, 2, 4, 6, 8) represents the transmission order of the divided blocks and (S41, S43, S45, S47, S42, S44, S46, S48) represents the sizes S41, S43, S45, S47, S42, S44, S46, S48 of respective blocks B41, B43, B45, B47, B42, B44, B46, B48 in a transmission order. The certification information 136 concerning a communication rule of “(P42) (S41, S43, S45, S47, S42, S44, S46, S48), (1, 3, 5, 7, 2, 4, 6, 8)” generated as described above is transmitted from the certification information generation part 131 to the certification information addition performing part 132. At the same time, the certification information 136 concerning a communication rule of “(P42) (S41, S43, S45, S47, S42, S44, S46, S48), (1, 3, 5, 7, 2, 4, 6, 8)” is transmitted to the certification information verification part 141 of the authentication part 140.

Note, the above certification information 136 concerning a communication rule is just one example and it is not intended to be restricted to content as described above. It is possible to generate certification information 136 concerning a communication rule using any communication rule and a way of expression thereof used for transmission from the certification information addition performing part 132 to the certification information verification part 141. Furthermore, in a case where a plurality of communication rules and symbols or signs and so on associated to the plurality of communication rules are known to both the certification information adding part 130 and an authentication part 140 in advance, certification information 136 concerning a communication rule may be generated by selecting symbols or signs and so on associated to a communication rule to be used among a plurality of communication rules. For example, in a case where “(P41) (S41, S42, S43, S44, S45, S46, S47, S48), (1, 2, 3, 4, 5, 6, 7, 8)” and “(P42) (S41, S43, S45, S47, S42, S44, S46, S48), (1, 3, 5, 7, 2, 4, 6, 8)” as shown in the above examples are known to both the certification information adding part 130 and an authentication part 140, only “P41” or only “P42” may be generated and used as certification information 136 concerning a communication rule.

Furthermore, it is possible to use different certification information 136 concerning a communication rule from moment to moment. As an example, certification information 136 concerning a communication rule of “(P41) (S41, S42, S43, S44, S45, S46, S47, S48), (1, 2, 3, 4, 5, 6, 7, 8)” as shown in (B) of FIG. 5 can be used at a moment and, on the one hand, certification information 136 concerning a communication rule of “(P42) (S41, S43, S45, S47, S42, S44, S46, S48), (1, 3, 5, 7, 2, 4, 6, 8)” as shown in (B) of FIG. 5 can be used at a different moment. By using different certification information 136 concerning a communication rule from moment to moment, for example in a regular way or randomly, it becomes possible to effectively prevent an authentication of a user using biometric information other than biometric information acquired through a legitimate route from being performed.

(C41) of FIG. 5 shows a case where encrypted first biometric information 411 is transmitted from the certification information addition performing part 132 to the certification information verification part 141 using a communication rule shown by the certification information 136 concerning a communication rule of “(P41) (S41, S42, S43, S44, S45, S46, S47, S48), (1, 2, 3, 4, 5, 6, 7, 8)” as shown in (B) of FIG. 5 as generated above. As shown in (C41) of FIG. 5, respective blocks B41, B42, B43, B44, B45, B46, B47 and B48 are transmitted in sequence and, for example, the certification information 136 concerning a communication rule shown by “(P41) (S41, S42, S43, S44, S45, S46, S47, S48), (1, 2, 3, 4, 5, 6, 7, 8)” shown in (B) of FIG. 5 is transmitted at the end. By this, authentication information 437 including the certification information 136 concerning the communication rule and the encrypted first biometric information 411 configured according to the communication rule shown by the certification information 136 concerning the communication rule of “(P41) (S41, S42, S43, S44, S45, S46, S47, S48), (1, 2, 3, 4, 5, 6, 7, 8)” are transmitted from the certification information addition performing part 132 of the certification information adding part 130 to the certification information verification part 141 of the authentication part 140. Note, the encrypted first biometric information 411 configured according to the communication rule shown by the certification information 136 concerning the communication rule of “(P41) (S41, S42, S43, S44, S45, S46, S47, S48), (1, 2, 3, 4, 5, 6, 7, 8)” represents that the encrypted first biometric information 411 to be transmitted is divided to blocks and sizes of the blocks and a transmission order thereof are configured according to a communication rule shown by the certification information 136 concerning the communication rule of “(P41) (S41, S42, S43, S44, S45, S46, S47, S48), (1, 2, 3, 4, 5, 6, 7, 8)”.

In a case where encrypted first biometric information 411 is transmitted from the certification information addition performing part 132 to the certification information verification part 141 using a communication rule shown by the certification information 136 concerning a communication rule of “(P42) (S41, S43, S45, S47, S42, S44, S46, S48), (1, 3, 5, 7, 2, 4, 6, 8)” as shown in (B) of FIG. 5 as generated above, as shown in (C42) of FIG. 5, respective blocks B41, B43, B45, B47, B42, B44, B46 and B48 are transmitted and, for example, the certification information 136 concerning a communication rule as shown in “(P42) (S41, S43, S45, S47, S42, S44, S46, S48), (1, 3, 5, 7, 2, 4, 6, 8)” shown in (B) of FIG. 5 is transmitted at the end. By this, authentication information 437 including the certification information 136 concerning the communication rule and the encrypted first biometric information 411 configured according to the communication rule shown by the certification information 136 concerning the communication rule of “(P42) (S41, S43, S45, S47, S42, S44, S46, S48), (1, 3, 5, 7, 2, 4, 6, 8)” are transmitted from the certification information addition performing part 132 of the certification information adding part 130 to the certification information verification part 141 of the authentication part 140. Note, the encrypted first biometric information 411 configured according to the communication rule shown by the certification information 136 concerning the communication rule of “(P42) (S41, S43, S45, S47, S42, S44, S46, S48), (1, 3, 5, 7, 2, 4, 6, 8)” represents that the encrypted first biometric information 411 to be transmitted is divided to blocks and sizes of the blocks and a transmission order thereof are configured according to a communication rule shown by the certification information 136 concerning the communication rule of “(P42) (S41, S43, S45, S47, S42, S44, S46, S48), (1, 3, 5, 7, 2, 4, 6, 8)”.

Next, an operation of the certification information verification part 141 of the authentication part 140 which has received certification information 136 concerning a communication rule and authentication information 437 will be described with reference to FIG. 4.

The certification information verification part 141 receives the authentication information 437 from the certification information addition performing part 132 of the certification information adding part 130 and verifies legitimacy of the certification information 136 concerning a communication rule in the authentication information 437 received from the certification information adding part using the certification information 136 concerning a communication rule notified in advance from the certification information generation part 131 of the certification information adding part 130.

In a case where an authentication of a user is performed using biometric information acquired through a legitimate route, certification information 136 concerning a communication rule in authentication information 437 is the same as certification information 136 concerning a communication rule notified in advance from the certification information generation part 131. In such case, the certification information verification part 141 determines that the certification information 136 concerning the communication rule in the authentication information 437 is legitimate. Then, the certification information verification part 141 transmits to the authentication performing part 442 the encrypted first biometric information 411 in which an order of the blocks is restored to the same order of the blocks as that in the encrypted first biometric information 411 before configuration has been performed according to a communication rule which is shown by the certification information 136 concerning the communication rule, from an order of blocks of the encrypted first biometric information 411 configured according to the communication rule represented in the certification information 136 concerning the communication rule in the authentication information 437, based on the certification information 136 concerning the communication rule in the authentication information 437 or notified from the certification information adding part 130 in advance.

The authentication performing part 442 in the authentication part 140, with reference to the encrypted second biometric information 412 included in the biometric information database 120, performs an authentication of a user using the encrypted first biometric information 411 in which an order of the blocks is restored to the same order of the blocks as that before configuration has been performed according to a communication rule shown by the certification information 136 concerning the communication rule. In another example, an authentication of a user is performed using the encrypted first biometric information 411 in the authentication information 437 according to the communication rule shown by the certification information 136 concerning the communication rule. Note, in a case where the first biometric information and the second biometric information are encrypted, for example, by using a homomorphic encryption, the authentication performing part 442 can compare the first biometric information 111 and the second biometric information 112 while they are kept encrypted, such as the encrypted first biometric information and the encrypted second biometric information.

Next, in the second example embodiment of the present invention as shown in FIG. 4, an operation will be described below, in a case where encrypted second biometric information 412 of a user stored in advance in the biometric information database 120 has been stolen by a fraudulent user and is inputted to the authentication part 140 through a fraudulent route 300 without passing through the certification information adding part 130 as authentication information 437 including encrypted first biometric information 411.

In a case where certification information 136 concerning a communication rule is not added to authentication information 437 received by the certification information verification part 141 of the authentication part 140 or in a case where certification information 136 concerning a communication rule in received authentication information 437 is incorrect, the certification information verification part 141 determines that authentication information 437 does not contain first biometric information 111 of a user which is inputted through a legitimate route from an input 200 and transmitted from the certification information addition performing part 132 of the certification information adding part 130. Then, the certification information verification part 141 does not transmit the encrypted first biometric information 411 in the inputted authentication information 437 to the authentication performing part 142 and halts processings. As a result, the authentication performing part 442 does not performs an authentication of a user.

As a result, it is possible to prevent a user authentication using biometric information other than biometric information acquired through a legitimate route from being performed.

As described above, according to the second example embodiment of the present invention, it is possible to provide an authentication apparatus, an authentication method, and a program which is capable to contribute to prevent a user authentication using biometric information other than biometric information acquired through a legitimate route from being performed because an authentication of a user is performed using the encrypted first biometric information 411 only in a case where legitimacy of the certification information 136 concerning a communication rule in the authentication information 437 is verified and the certification information 136 in the authentication information 437 is determined to be legitimate.

### Third Example Embodiment

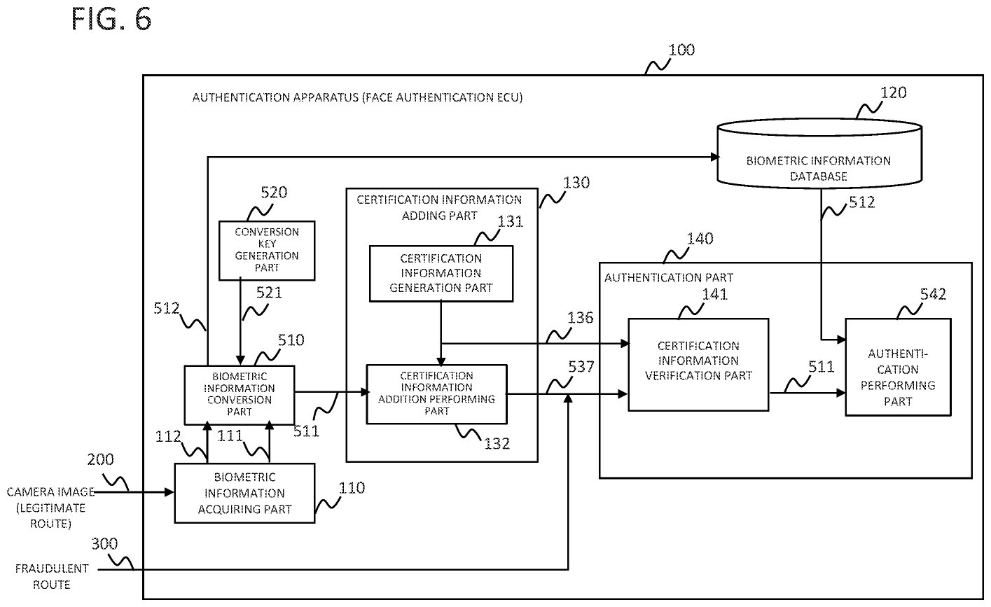

Next, an authentication apparatus of a third example embodiment of the present invention will be described with reference to drawings. FIG. 6 is a diagram illustrating an example of a configuration of an authentication apparatus according to the third example embodiment of the present invention. In FIG. 6, components denoted by the same reference numerals as those in FIG. 2 indicate the same components. An authentication apparatus 100 according to the third example embodiment includes a configuration in which a conversion key generation part 520 and a biometric information conversion part 510 is further provided to the authentication apparatus 100 according to the first example embodiment. The conversion key generation part 520 generates a conversion key 521. The biometric information conversion part 510 performs a conversion of first biometric information 111 acquired by a biometric information acquiring part 110 based on the conversion key 521, transmits it to a certification information adding part 130, and performs a conversion of second biometric information 112 based on the conversion key 521.

The third example embodiment of the present invention is an example embodiment of the present invention in which the cancellable biometric authentication technology as described above is used, as an example.

In the third example embodiment of the present invention, it is described that, as an example, at a registration phase, second biometric information 112 of a user to be authenticated acquired by a biometric information acquiring part 110 is converted based on a conversion key 521 by the biometric information conversion part 510 and stored in a biometric information database 120 in advance as a converted second biometric information 512. However, the converted second biometric information 512 in the biometric information database 120 may be stored in the biometric information database 120 in advance at a registration stage by converting a second biometric information 112 of a user to be authenticated acquired outside an authentication apparatus 100 based on a conversion key 521.

Furthermore, first biometric information 111 of a user to be authenticated acquired by a biometric information acquiring part 110 is converted based on a conversion key 521 by the biometric information conversion part 510 and supplied to the certification information addition performing part 132 as converted first biometric information 511.

The certification information addition performing part 132 of the certification information adding part 130 receives the converted first biometric information 511 based on a conversion key 521 from the biometric information conversion part 510. The certification information generation part 131 of the certification information adding part 130 generates certification information 136 concerning a communication rule and notifies the certification information verification part 141 in the authentication part 140 of the certification information 136 concerning a communication rule in advance. Furthermore, the certification information addition performing part 132 of the certification information adding part 130 receives the certification information 136 concerning a communication rule from the certification information generation part 131 and transmits authentication information 537 including the certification information 136 concerning the communication rule and the converted first biometric information 511 configured according to the communication rule shown by the certification information 136 concerning the communication rule to the certification information verification part 141 of the authentication part 140.

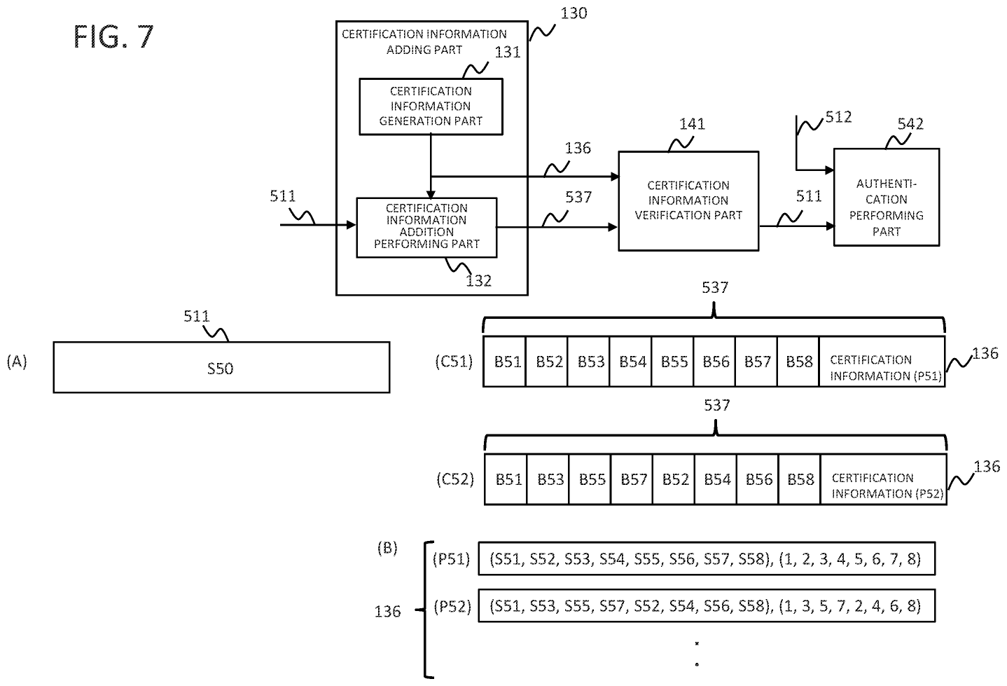

Next, an example of an operation of the certification information generation part 131 will be described with reference to FIG. 7. FIG. 7 is a diagram illustrating an example of an operation of a certification information adding part 130 according to the third example embodiment of the present invention. The certification information generation part 131 generates the certification information 136 concerning a communication rule based on a communication rule used when the certification information addition performing part 132 transmits the inputted converted first biometric information 511 to the certification information verification part 141.

As an example, the certification information generation part 131 generates the certification information 136 concerning a communication rule as shown in (B) of FIG. 7.

“(P51) (S51, S52, S53, S54, S55, S56, S57, S58), (1, 2, 3, 4, 5, 6, 7, 8)” as shown in (B) of FIG. 7 represents an example of the certification information 136 concerning a communication rule generated by the certification information generation part 131. The communication rule shown by the certification information 136 concerning a communication rule of “(P51) (S51, S52, S53, S54, S55, S56, S57, S58), (1, 2, 3, 4, 5, 6, 7, 8)” is a communication rule which represents that converted first biometric information 511 of a size S50 inputted to the certification information addition performing part 132 is divided to 8 blocks B51 to B58, respective blocks B51 to B58 have sizes of S51 to S58, and the blocks B51 to B58 are transmitted from the certification information addition performing part 132 to the certification information verification part 141 in an order of B51, B52, B53, B54, B55, B56, B57 and B58. (1, 2, 3, 4, 5, 6, 7, 8) represents the transmission order of the divided blocks and (S51, S52, S53, S54, S55, S56, S57, S58) represents the sizes S51, S52, S53, S54, S55, S56, S57, S58 of respective blocks B51, B52, B53, B54, B55, B56, B57 and B58 in a transmission order. The certification information 136 concerning a communication rule of “(P51) (S51, S52, S53, S54, S55, S56, S57, S58), (1, 2, 3, 4, 5, 6, 7, 8)” generated as described above is transmitted from the certification information generation part 131 to the certification information addition performing part 132. At the same time, the certification information 136 concerning a communication rule of “(P51) (S51, S52, S53, S54, S55, S56, S57, S58), (1, 2, 3, 4, 5, 6, 7, 8)” is transmitted to the certification information verification part 141 of the authentication part 140.

“(P52) (S51, S53, S55, S57, S52, S54, S56, S58), (1, 3, 5, 7, 2, 4, 6, 8)” as shown in (B) of FIG. 7 represents another example of the certification information 136 concerning a communication rule generated by the certification information generation part 131. The communication rule shown by the certification information 136 concerning a communication rule of “(P52) (S51, S53, S55, S57, S52, S54, S56, S58), (1, 3, 5, 7, 2, 4, 6, 8)” is a communication rule which represents that converted first biometric information 511 of a size S50 inputted to the certification information addition performing part 132 is divided to 8 blocks B51 to B58, respective blocks B51 to B58 have sizes of S51 to S58, and the blocks B51 to B58 are transmitted from the certification information addition performing part 132 to the certification information verification part 141 in an order of B51, B53, B55, B57, B52, B54, B56 and B58. (1, 3, 5, 7, 2, 4, 6, 8) represents the transmission order of the divided blocks and (S51, S53, S55, S57, S52, S54, S56, S58) represents the sizes S51, S53, S55, S57, S52, S54, S56, S58 of respective blocks B51, B53, B55, B57, B52, B54, B56, B58 in a transmission order. The certification information 136 concerning a communication rule of “(P52) (S51, S53, S55, S57, S52, S54, S56, S58), (1, 3, 5, 7, 2, 4, 6, 8)” generated as described above is transmitted from the certification information generation part 131 to the certification information addition performing part 132. At the same time, the certification information 136 concerning a communication rule of “(P52) (S51, S53, S55, S57, S52, S54, S56, S58), (1, 3, 5, 7, 2, 4, 6, 8)” is transmitted to the certification information verification part 141 of the authentication part 140.

Note, the above certification information 136 concerning a communication rule is just one example and it is not intended to be restricted to content as described above. It is possible to generate certification information 136 concerning a communication rule using any communication rule and a way of expression thereof used for transmission from the certification information addition performing part 132 to the certification information verification part 141. Furthermore, in a case where a plurality of communication rules and symbols or signs and so on associated to the plurality of communication rules are known to both the certification information adding part 130 and an authentication part 140 in advance, certification information 136 concerning a communication rule may be generated by selecting symbols or signs and so on associated to a communication rule to be used among a plurality of communication rules. For example, in a case where “(P51) (S51, S52, S53, S54, S55, S56, S57, S58), (1, 2, 3, 4, 5, 6, 7, 8)” and “(P52) (S51, S53, S55, S57, S52, S54, S56, S58), (1, 3, 5, 7, 2, 4, 6, 8)” as shown in the above examples are known to both the certification information adding part 130 and an authentication part 140, only “P51” or only “P52” may be generated and used as certification information 136 concerning a communication rule.

Furthermore, it is possible to use different certification information 136 concerning a communication rule from moment to moment. As an example, certification information 136 concerning a communication rule of “(P51) (S51, S52, S53, S54, S55, S56, S57, S58), (1, 2, 3, 4, 5, 6, 7, 8)” as shown in (B) of FIG. 7 can be used at a moment and certification information 136 concerning a communication rule of “(P52) (S51, S53, S55, S57, S52, S54, S56, S58), (1, 3, 5, 7, 2, 4, 6, 8)” as shown in (B) of FIG. 7 can be used at a difference moment. By using different certification information 136 concerning a communication rule from moment to moment, for example in a regular way or randomly, it becomes possible to effectively prevent an authentication of a user using biometric information other than biometric information acquired through a legitimate route from being performed.

(C51) of FIG. 7 shows a case where converted first biometric information 511 is transmitted from the certification information addition performing part 132 to the certification information verification part 141 using a communication rule shown by the certification information 136 concerning a communication rule of “(P51) (S51, S52, S53, S54, S55, S56, S57, S58), (1, 2, 3, 4, 5, 6, 7, 8)” as shown in (B) of FIG. 7 as generated above. As shown in (C51) of FIG. 7, respective blocks B51, B52, B53, B54, B55, B56, B57 and B58 are transmitted in sequence and, for example, the certification information 136 concerning a communication rule shown by “(P51) (S51, S52, S53, S54, S55, S56, S57, S58), (1, 2, 3, 4, 5, 6, 7, 8)” shown in (B) of FIG. 7 is transmitted at the end. By this, authentication information 537 including the certification information 136 concerning the communication rule and the converted first biometric information 511 configured according to the communication rule shown by the certification information 136 concerning the communication rule of “(P51) (S51, S52, S53, S54, S55, S56, S57, S58), (1, 2, 3, 4, 5, 6, 7, 8)” are transmitted from the certification information addition performing part 132 of the certification information adding part 130 to the certification information verification part 141 of the authentication part 140. Note, the converted first biometric information 511 configured according to the communication rule shown by the certification information 136 concerning the communication rule of “(P51) (S51, S52, S53, S54, S55, S56, S57, S58), (1, 2, 3, 4, 5, 6, 7, 8)” represents that the converted first biometric information 511 to be transmitted is divided to blocks and sizes of the blocks and a transmission order thereof are configured according to a communication rule shown by the certification information 136 concerning the communication rule of “(P51) (S51, S52, S53, S54, S55, S56, S57, S58), (1, 2, 3, 4, 5, 6, 7, 8)”.

In a case where converted first biometric information 511 is transmitted from the certification information addition performing part 132 to the certification information verification part 141 using a communication rule shown by the certification information 136 concerning a communication rule of “(P52) (S51, S53, S55, S57, S52, S54, S56, S58), (1, 3, 5, 7, 2, 4, 6, 8)” as shown in (B) of FIG. 7 as generated above, as shown in (C52) of FIG. 7, respective blocks B51, B53, B55, B57, B52, B54, B56 and B58 are transmitted and, for example, the certification information 136 concerning a communication rule as shown in “(P52) (S51, S53, S55, S57, S52, S54, S56, S58), (1, 3, 5, 7, 2, 4, 6, 8)” shown in (B) of FIG. 7 is transmitted at the end. By this, authentication information 537 including the certification information 136 concerning the communication rule and the converted first biometric information 511 configured according to the communication rule shown by the certification information 136 concerning the communication rule of “(P52) (S51, S53, S55, S57, S52, S54, S56, S58), (1, 3, 5, 7, 2, 4, 6, 8)” are transmitted from the certification information addition performing part 132 of the certification information adding part 130 to the certification information verification part 141 of the authentication part 140. Note, the converted first biometric information 511 configured according to the communication rule shown by the certification information 136 concerning the communication rule of “(P52) (S51, S53, S55, S57, S52, S54, S56, S58), (1, 3, 5, 7, 2, 4, 6, 8)” represents that the converted first biometric information 511 to be transmitted is divided to blocks and sizes of the blocks and a transmission order thereof are configured according to a communication rule shown by the certification information 136 concerning the communication rule of “(P52) (S51, S53, S55, S57, S52, S54, S56, S58), (1, 3, 5, 7, 2, 4, 6, 8)”.

Next, an operation of the certification information verification part 141 of the authentication part 140 which has received certification information 136 concerning a communication rule and authentication information 537 will be described with reference to FIG. 6.

The certification information verification part 141 receives the authentication information 537 from the certification information addition performing part 132 of the certification information adding part 130 and verifies legitimacy of the certification information 136 concerning a communication rule in the authentication information 537 received from the certification information adding part using the certification information 136 concerning a communication rule notified in advance from the certification information generation part 131 of the certification information adding part 130.

In a case where an authentication of a user is performed using biometric information acquired through a legitimate route, certification information 136 concerning a communication rule in authentication information 537 is the same as certification information 136 concerning a communication rule notified in advance from the certification information generation part 131. In such case, the certification information verification part 141 determines that the certification information 136 concerning the communication rule in the authentication information 537 is legitimate. Then, the certification information verification part 141 transmits to the authentication performing part 542 the converted first biometric information 511 in which an order of the blocks is restored to the same order of the blocks as that in the converted first biometric information 511 before configuration has been performed according to a communication rule which is shown by the certification information 136 concerning the communication rule, from an order of blocks of the converted first biometric information 511 configured according to the communication rule represented in the certification information 136 concerning the communication rule in the authentication information 537, based on the certification information 136 concerning the communication rule in the authentication information 537 or notified from the certification information adding part 130 in advance.

The authentication performing part 542 in the authentication part 140, with reference to the converted second biometric information 512 included in the biometric information database 120, performs an authentication of a user using the converted first biometric information 511 in which an order of the blocks is restored to the same order of the blocks as that before configuration has been performed according to a communication rule shown by the certification information 136 concerning the communication rule. In another example, an authentication of a user is performed using the converted first biometric information 511 in the authentication information according to the communication rule shown by the certification information 136 concerning the communication rule. Note, for example, a conversion based on a conversion key may be one way conversion. Furthermore, for example, one way conversion may be a permutation of elements making up second biometric information 112 and first biometric information 111 based on a conversion key. The authentication performing part 542 can compare the second biometric information 112 and the first biometric information 111 while they are kept converted, such as the converted second biometric information and the converted first biometric information.

Next, in the third example embodiment of the present invention as shown in FIG. 6, an operation will be described below, in a case where converted second biometric information 512 of a user stored in advance in the biometric information database 120 has been stolen by a fraudulent user and is inputted to the authentication part 140 through a fraudulent route 300 without passing through the certification information adding part 130 as authentication information 537 including converted first biometric information 511.

In a case where certification information 136 concerning a communication rule is not added to authentication information 537 received by the certification information verification part 141 of the authentication part 140 or in a case where certification information 136 concerning a communication rule in received authentication information 537 is incorrect, the certification information verification part 141 determines that authentication information 537 does not contain first biometric information 111 of a user which is inputted through a legitimate route from an input 200 and transmitted from the certification information addition performing part 132 of the certification information adding part 130. Then, the certification information verification part 141 does not transmit the converted first biometric information 511 in the inputted authentication information 537 to the authentication performing part 142 and halts processings. As a result, the authentication performing part 542 does not performs an authentication of a user.

As a result, it is possible to prevent a user authentication using biometric information other than biometric information acquired through a legitimate route from being performed.

As described above, according to the third example embodiment of the present invention, it is possible to provide an authentication apparatus, an authentication method, and a program which is capable to contribute to prevent a user authentication using biometric information other than biometric information acquired through a legitimate route from being performed because an authentication of a user is performed using the converted first biometric information 511 only in a case where legitimacy of the certification information 136 concerning a communication rule in the authentication information 537 is verified and the certification information 136 in the authentication information 537 is determined to be legitimate.

The example embodiments of the present invention have been described as above, however, the present invention is not limited thereto. Further modifications, substitutions, or adjustments can be made without departing from the basic technical concept of the present invention. For example, the configurations of the networks and the elements and the representation modes of the message or the like illustrated in the individual drawings are merely used as examples to facilitate the understanding of the present invention. Thus, the present invention is not limited to the configurations illustrated in the drawings. In addition, “A and/or B” signifies at least one of A or B.

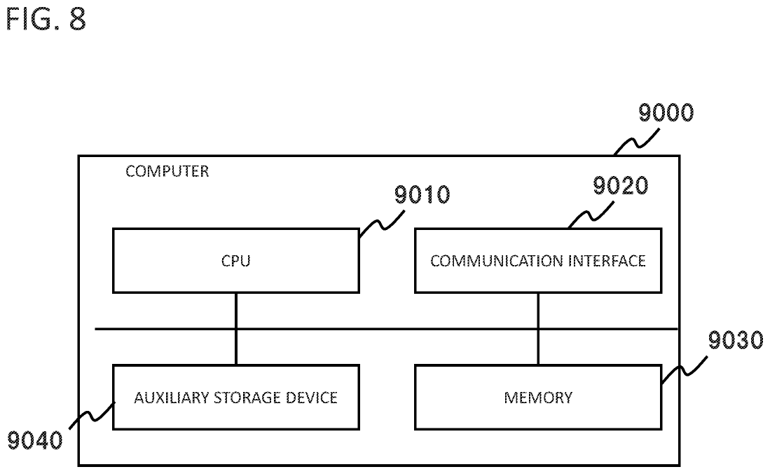

In addition, the procedures described in the above first to third example embodiments can each be realized by a program causing a computer (9000 in FIG. 8) functioning as the authentication apparatus of the present invention to realize the functions as the authentication apparatus. For example, this computer is configured to include a CPU (Central Processing Unit) 9010, a communication interface 9020, a memory 9030, and an auxiliary storage device 9040 in FIG. 8. That is, the CPU 9010 in FIG. 8 executes a control program of an authentication apparatus and performs processing for updating various calculation parameters stored in the auxiliary storage device 9040 or the like.

The memory 9030 is a RAM (Random Access Memory) or a ROM (Read-Only Memory), and so on.

That is, the individual parts (processing means, functions) of each of the authentication apparatus in the first to third example embodiments as described above can each be realized by a computer program that causes a processor of the computer to execute the corresponding processing described above by using corresponding hardware.

Finally, suitable modes of the present invention will be summarized.

### [Mode 1]

(See the authentication apparatus according to the above first aspect)

### [Mode 2]

The authentication apparatus according to mode 1 is preferable that, wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

### [Mode 3]

The authentication apparatus according to mode 1 or 2, further comprising:
a biometric information encryption part which encrypts the first biometric information acquired by the biometric information acquiring part using a predetermined encryption and transmits the encrypted first biometric information to the certification information adding part; and the second biometric information of the user in the biometric information database is encrypted using the predetermined encryption.

### [Mode 4]

The authentication apparatus according to mode 3 is preferable that, wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

### [Mode 5]

The authentication apparatus according to mode 3 is preferable that, wherein the predetermined encryption is a homomorphic encryption.

### [Mode 6]

The authentication apparatus according to mode 1 or 2, further comprising:
a conversion key generation part which generates a conversion key; and

a biometric information conversion part which converts the first biometric information acquired by the biometric information acquiring part based on the conversion key and transmits the converted first biometric information to the certification information adding part;
wherein the second biometric information of the user in the biometric information database has been converted based on the conversion key.

### [Mode 7]

The authentication apparatus according to mode 6 is preferable that, wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

### [Mode 8]

The authentication apparatus according to mode 6 is preferable that, wherein the conversion based on the conversion key is a one-way conversion.

### [Mode 9]

(See the authentication method according to the above second aspect)

### [Mode 10]

(See the program according to the above third aspect)

The above modes 9 and 10 can be expanded to the modes 2 to 8 in the same way as the mode 1 is expanded.

### [Mode 11]

The authentication apparatus according to mode 1 is preferable that, wherein the first biometric information in the authentication information transmitted from the certification information adding part to the authentication part is configured in such way that the first biometric information is divided to a plurality of blocks to be arranged in a predetermined transmission order according to the communication rule shown by the certification information concerning the communication rule; and
wherein the certification information concerning the communication rule includes each size of the plurality of blocks of the first biometric information which is divided to the plurality of blocks to be arranged in the authentication information and the predetermined transmission order of the plurality of blocks.

### [Mode 12]

The authentication apparatus according to mode 1 or 11, further comprising:
a biometric information encryption part which encrypts the first biometric information acquired by the biometric information acquiring part using a predetermined encryption; and
the second biometric information of the user in the biometric information database stored in advance is encrypted using the predetermined encryption, and the first biometric information of the user received by the certification information adding part is encrypted using the predetermined encryption by the biometric information encryption part.

### [Mode 13]

The authentication apparatus according to mode 12 is preferable that, wherein the first biometric information in the authentication information transmitted from the certification information adding part to the authentication part is configured in such way that the first biometric information is divided to a plurality of blocks to be arranged in a predetermined transmission order according to the communication rule shown by the certification information concerning the communication rule; and
wherein the certification information concerning the communication rule includes each size of the plurality of blocks of the first biometric information which is divided to the plurality of blocks to be arranged in the authentication information and the predetermined transmission order of the plurality of blocks.

### [Mode 14]

The authentication apparatus according to mode 1 or 11, further comprising:
a conversion key generation part which generates a conversion key; and
a biometric information conversion part which converts the first biometric information acquired by the biometric information acquiring part based on the conversion key;
wherein the second biometric information of the user in the biometric information database stored in advance has been converted based on the conversion key, and
the first biometric information received by the certification information adding part is converted based on the conversion key by the biometric information conversion part.

### [Mode 15]

The authentication apparatus according to mode 14 is preferable that, wherein the first biometric information in the authentication information transmitted from the certification information adding part to the authentication part is configured in such way that the first biometric information is divided to a plurality of blocks to be arranged in a predetermined transmission order according to the communication rule shown by the certification information concerning the communication rule; and
wherein the certification information concerning the communication rule includes each size of the plurality of blocks of the first biometric information which is divided to the plurality of blocks to be arranged in the authentication information and the predetermined transmission order of the plurality of blocks.

The disclosure of each of the above PTLs is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed. In addition, each disclosure of above cited documents and also using a part or all thereof by combining with the disclosure of the present application are regarded as being included in the disclosure of the present application, as necessary, in accordance with the intent of the present invention, as a part of the disclosure of the present invention.

### REFERENCE SIGNS LIST

100 authentication apparatus
110 biometric information acquiring part
111 first biometric information
112 second biometric information
120 biometric information database
130 certification information adding part
131 certification information generation part
132 certification information addition performing part
136 certification information concerning a communication rule
137, 437, 537 authentication information
140 authentication part
141 certification information verification part
142, 442, 542 authentication performing part
410 biometric information encryption part
411 encrypted first biometric information
412 encrypted second biometric information
510 biometric information conversion part
511 converted first biometric information
512 converted second biometric information
520 conversion key generation part
521 conversion key
9000 computer
9010 CPU
9020 communication interface
9030 memory
9040 auxiliary storage device

What is claimed is:

1. An authentication apparatus, comprising:
at least a processor; and
a memory in circuit communication with the processor,
wherein the processor is configured to execute program instructions stored in the memory to implement:
a biometric information acquiring part which acquires first biometric information of a user;
a certification information adding part;
an authentication part; and
a biometric information database which includes second biometric information of the user;
wherein the certification information adding part
notifies the authentication part of certification information concerning a communication rule in advance, and
transmits authentication information including the certification information and the first biometric information configured according to the communication rule to the authentication part; and
wherein the authentication part
receives the authentication information, and
verifies legitimacy of the certification information in the authentication information using the certification information notified in advance from the certification information adding part; and
performs authentication of the user using the first biometric information in the authentication information with reference to the second biometric information included in the biometric information database, in a case where the certification information in the authentication information is determined to be legitimate.

2. The authentication apparatus according to claim 1,
wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

3. The authentication apparatus according to claim 1, wherein the processor is configured to execute the program instructions to implement:
a biometric information encryption part which encrypts the first biometric information acquired by the biometric information acquiring part using a predetermined encryption and transmits the encrypted first biometric information to the certification information adding part; and
the second biometric information of the user in the biometric information database is encrypted using the predetermined encryption.

4. The authentication apparatus according to claim 3,
wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

5. The authentication apparatus according to claim 3,
wherein the predetermined encryption is a homomorphic encryption.

6. The authentication apparatus according to claim 1, wherein the processor is configured to execute the program instructions to implement:
a conversion key generation part which generates a conversion key; and
a biometric information conversion part which converts the first biometric information acquired by the biometric information acquiring part based on the conversion key and transmits the converted first biometric information to the certification information adding part;
wherein the second biometric information of the user in the biometric information database has been converted based on the conversion key.

7. The authentication apparatus according to claim 6,
wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

8. The authentication apparatus according to claim 6,
wherein the conversion based on the conversion key is a one-way conversion.

9. An authentication method performed by an authentication apparatus, comprising:
a biometric information acquiring part which acquires first biometric information of a user;
a certification information adding part;
an authentication part; and
a biometric information database which includes second biometric information of the user;
wherein the certification information adding part
notifies the authentication part of certification information concerning a communication rule in advance, and
transmits authentication information including the certification information and the first biometric information configured according to the communication rule to the authentication part; and
wherein the authentication part
receives the authentication information, and
verifies legitimacy of the certification information in the authentication information using the certification information notified in advance from the certification information adding part; and
performs authentication of the user using the first biometric information in the authentication information with reference to the second biometric information included in the biometric information database, in a case where the certification information in the authentication information is determined to be legitimate.

10. The authentication method according to claim 9,
wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

11. The authentication method according to claim 9, the authentication apparatus further comprising:
a biometric information encryption part which encrypts the first biometric information acquired by the biometric information acquiring part using a predetermined encryption and transmits the encrypted first biometric information to the certification information adding part; and
the second biometric information of the user in the biometric information database is encrypted using the predetermined encryption.

12. The authentication method according to claim 11,
wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

13. The authentication method according to claim 11,
wherein the predetermined encryption is a homomorphic encryption.

14. The authentication method according to claim 9, the authentication apparatus further comprising:
a conversion key generation part which generates a conversion key; and
a biometric information conversion part which converts the first biometric information acquired by the biometric information acquiring part based on the conversion key and transmits the converted first biometric information to the certification information adding part;
wherein the second biometric information of the user in the biometric information database has been converted based on the conversion key.

15. A computer-readable non-transitory recording medium recording a program, the program which causes a computer in an authentication apparatus comprising:
a biometric information acquiring part which acquires first biometric information of a user, and
a biometric information database which includes second biometric information of the user,
to perform processings of:
notifying certification information concerning a communication rule in advance, and
transmitting authentication information including the certification information and the first biometric information configured according to the communication rule,
whereby the program causes the computer to realize a function of a certification information adding part; and
causes the computer to perform processings of:
receiving the authentication information, and
verifying legitimacy of the certification information in the authentication information using the certification information notified in advance from the processing of notifying in advance; and
performing authentication of the user using the first biometric information in the authentication information with reference to the second biometric information included in the biometric information database, in a case where the certification information in the authentication information is determined to be legitimate,
whereby the program causes the computer to realize a function of an authentication part.

16. The medium according to claim 15,
wherein the first biometric information in the authentication information transmitted from the certification information adding part to the authentication part is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

17. The medium according to claim 15, the program further makes the computer to perform processings of:
encrypting the first biometric information using a predetermined encryption and transmitting the encrypted first biometric information; and
the second biometric information of the user in the biometric information database is encrypted using the predetermined encryption.

18. The medium according to claim 17,
wherein the first biometric information in the authentication information is configured in such way that the first biometric information is divided to a plurality of blocks to be arranged in a predetermined transmission order according to the communication rule; and
wherein the certification information includes each size of the plurality of blocks of the first biometric information which is divided to the plurality of blocks to be arranged in the authentication information and the predetermined transmission order of the plurality of blocks.

19. The medium according to claim 17,
wherein the predetermined encryption is a homomorphic encryption.

20. The medium according to claim 15, the program further makes the computer to perform processings of:
generating a conversion key; and
converting the first biometric information acquired by the biometric information acquiring part based on the conversion key and transmitting the converted first biometric information;
wherein the second biometric information of the user in the biometric information database has been converted based on the conversion key.
